(19) United States
(12) Patent Application Publication
(10) Pub. No.: US 2023/0342367 A1
(43) Pub. Date: Oct. 26, 2023

(54) STORAGE RECORD ENGINE IMPLEMENTING EFFICIENT TRANSACTION REPLAY

(71) Applicant: Alibaba Group Holding Limited, Grand Cayman (KY)

(72) Inventors: Yikang Xu, Redmond, WA (US); Yu Du, Hangzhou (CN); Peng Xu, Milpitas, CA (US); Rui Wang, Redmond, WA (US)

(21) Appl. No.: 18/215,057

(22) Filed: Jun. 27, 2023

(30) Foreign Application Priority Data
Dec. 28, 2020 (WO) PCT/CN2020/140151

(51) Int. Cl. G06F 16/2457; G06F 16/23; G06F 16/22

(52) U.S. Cl. CPC G06F 16/24573; G06F 16/23; G06F 16/2228; G06F 9/466

(57) ABSTRACT

A storage record engine implemented on a storage system is provided. The storage record engine further organizes hosted storage of the storage system into superblocks and chunks organized by respective metadata, the chunks being further organized into chunk segments amongst superblocks. Persistent storage operations may cause modifications to the metadata, which may be recorded in a transaction log, records of which may be replayed to commit the modifications to hosted storage. The replay functionality may establish recovery of data following a system failure, wherein replay of records of transaction logs in a fashion interleaved with checkpoint metadata avoids preemption of normal storage device activity during a recovery process, and improves responsiveness of the storage system from the perspective of end devices.

### CROSS REFERENCE TO RELATED APPLICATIONS

This application claims priority to and is a continuation of PCT Patent Application No. PCT/CN2020/140151, filed on 28 Dec. 2020 and entitled “STORAGE RECORD ENGINE IMPLEMENTING EFFICIENT TRANSACTION REPLAY,” which is incorporated herein by reference in its entirety.

### BACKGROUND

Data storage has increasingly entered the domain of cloud computing, wherein the hosting of file systems on networked, distributed servers allows availability and reliability of remotely stored files to be greatly enhanced, and enables data workloads to be serviced by likewise distributed computing resources, which may be scaled to meet the needs of large-scale computation applications and projects. As a consequence, it is desired for a hosted storage services to be accessible and responsive to the massive data storage needs of many client devices concurrently.

Additionally, reliability of remotely stored files commonly relies upon recordation of write transactions in transaction logs, and periodic commitment of the logged transactions to disk. Such implementations of backup and recovery functionality tends to work against the above-stated goals of accessible and responsive storage services, as commitment of transactions to disk tends to be very high in bandwidth, preempting other disk activity. As a result, services may become inaccessible or unresponsive for a noticeable and sustained period of time.

In order to maintain quality of storage services at acceptable standards, it is desirable to enable a storage system to concurrently process write transactions from a variety of sources, including external sources and internal sources, while implementing effective backup and recovery systems without leading to substantial degradation in storage performance. Additionally, even upon failure of the storage system leading to data loss, it is desirable to implement a recovery system which efficiently performs recovery and restores the system to functional capacity on an expeditious basis.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architectural diagram of a storage system according to example embodiments of the present disclosure.

FIG. 2 illustrates a superblock format according to example embodiments of the present disclosure.

FIG. 3 illustrates layout of data structures according to example embodiments of the present disclosure.

FIG. 4 illustrates a metadata commit method according to example embodiments of the present disclosure.

FIG. 5 illustrates a checkpoint write method according to example embodiments of the present disclosure.

FIG. 6 illustrates a layout of a metadata write stream encompassing records of a first record chain and a second record chain.

FIG. 7 illustrates a transaction log replay method according to example embodiments of the present disclosure.

FIG. 8 illustrates a full recovery scan method according to example embodiments of the present disclosure.

FIGS. 9A through 9C illustrate an example storage system for implementing the processes and methods described herein for transaction replay.

### DETAILED DESCRIPTION

Systems and methods discussed herein are directed to implementing data storage systems, and more specifically implementing a storage record engine of a storage system wherein replay of records of transaction logs in a fashion interleaved with checkpoint metadata avoids preemption of normal storage device activity during a recovery process, and improves responsiveness of the storage system from the perspective of end devices.

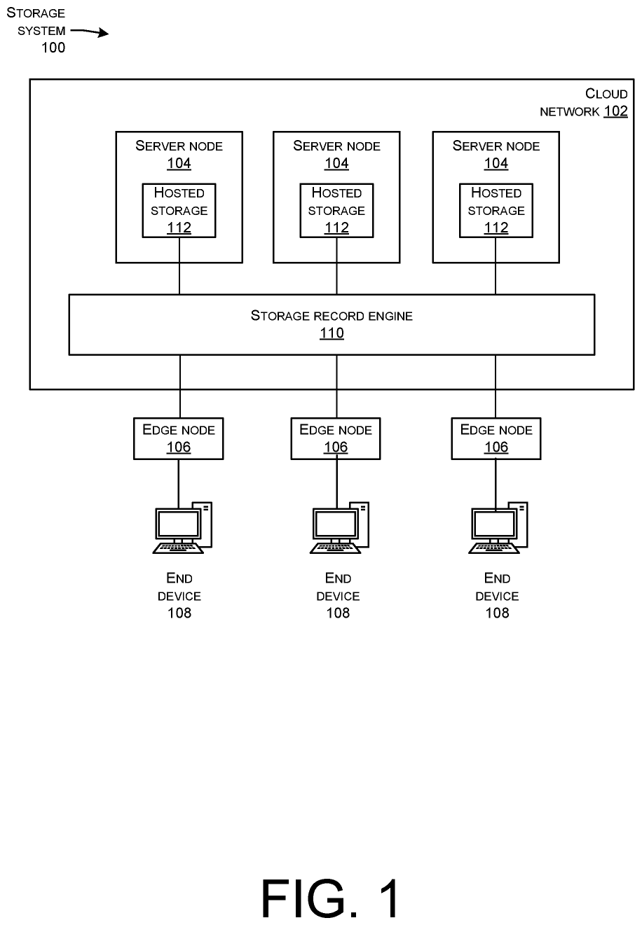

FIG. 1 illustrates an architectural diagram of a storage system 100 according to example embodiments of the present disclosure. The storage system 100 may be a cloud storage system, which may provide collections of servers hosting storage resources to provide distributed storage, improved availability of physical or virtual storage resources, and such benefits.

The storage system 100 may be implemented over a cloud network 102 of physical or virtual server nodes (where any unspecified server node may be referred to as a server node 104), connected by physical or virtual network connections. Furthermore, the network 102 may terminate at physical or virtual edge nodes (where any unspecified edge node may be referred to as an edge node 106) located at physical and/or logical edges of the cloud network 102. The edge nodes 106 may connect to any number of end devices (where any unspecified end device may be referred to as an end device 108).

A storage record engine 110 may be implemented on the cloud network 102. The storage record engine 110 may be configured to communicate with any number of end devices 108 by a network connection according to a file system communication protocol (such as a network file system communication protocol), a data query protocol, and the like, which implements one or more application programming interfaces (“APIs”) providing file operation calls. File system communication protocols as described herein may implement APIs such as Portable Operating System Interface (“POSIX”), Filesystem in Userspace (“FUSE”), Network File System (“NFS”), Representational State Transfer (“REST”) APIs, and the like, suitable for end devices 108 to express a file operation having various parameters. Data query protocols as described herein may implement APIs such as Structured Query Language (“SQL”) APIs suitable for end devices 108 to express a data store query having various parameters.

In either case, the storage record engine 110 is configured to communicate with any number of end devices 108 by a communication protocol which implements file and/or data operation calls on persistent storage, which include one or more of each type of operation conceptualized as “CRUD” in the art: one or more create operation(s), one or more read operation(s), one or more update operation(s), and one or more delete operation(s), each acting upon files and/or data on persistent storage, without limitation thereto. For brevity, the set of such operations implemented by the storage record engine 110 may be referred to as “persistent storage transactions.”

The storage record engine 110 may be further configured to execute persistent storage transactions by performing file and/or data operations on collective hosted storage 112 of any number of server nodes 104 of the cloud network 102. File and/or data operations may include logical file or data operations such as creating files and/or data store entries, deleting files and/or data store entries, reading from files and/or data store entries, writing to files and/or data store entries, renaming files and/or data store entries, moving a file and/or data store entry from one location to another location, and the like. The storage record engine 110 may perform all file system and/or data store management system functions required to support such operations, and furthermore may be configured to perform such file operations, and thus need not make any calls to other software layers, such as other file systems or database management systems, storage device drivers, and the like.

Physical and/or virtual storage devices (“hosted storage 112”) may be hosted at server nodes 104 of the cloud network 102. Data may be stored as logical blocks of a predetermined size, which may each be individually referred to as a “chunk.” Hosted storage 112 may be implemented as physical and/or virtual storage devices implementing read and write operations, data structures, storage device layout, and the like. Collectively, hosted storage 112 across server nodes 104 of the storage system 100 may be referred to as “cloud storage,” and any number of such storage devices may be virtualized as one storage device for the purpose of executing persistent storage transactions from one or more end devices 108.

Hosted storage 112 may include various forms of computer-readable storage media, which may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

It should be understood that storage devices may be implemented to permit write operations according to different data structures, disk layouts, and logic. For example, storage devices may be implemented to store sequential data structures which permit write operations in an append-only fashion, though such data structures may ultimately be erased to reclaim space. Alternatively, storage devices may be implemented to store data structures which are mutable at any time, such as tracks and sectors on a magnetic disk. Moreover, storage devices may implement additional storage layout controls, such as Zoned Namespaces (“ZNS”). In any case, block-based basic data structures may be written to the storage device, and it should be understood that magnetic disks, though conventionally implementing freely mutable data structures, may also implement sequential data structures which are written to in an append-only fashion. According to example embodiments of the present disclosure, hosted storage 112 may at least include some number of physical and/or virtual storage devices implemented at least in part using flash memory, such as solid-state drives (“SSDs”). However, hosted storage 112 may include any combination of magnetic disks, flash memory, and the like, on which write operations are implemented to write to sequential data structures in an append-only manner, whether additional storage layout controls such as ZNS are implemented therein or not. Example embodiments of the present disclosure as described below may be understood as implemented and proceeding substantially similarly regardless of the nature of the underlying storage devices.

The storage record engine 110 may configure hosted storage 112 collectively making up the cloud storage of the storage system 100 to store files and/or data store entries, as described above, in some number of basic data structures, which further store metadata describing layout and locations of each stored file and/or data store entry. Such metadata may configure a storage record engine 110 to map a logical file and/or data entry, as specified by an end device 108, to each location where data of that logical file and/or data entry is stored across cloud storage on one or more devices of hosted storage 112.

Basic data structures as described herein may include superblocks and chunks. While a “superblock” may have certain meanings in the context of file systems and data storage, for the purpose of example embodiments of the present disclosure, a superblock should be understood as implemented as a sequence of storage blocks of a storage device, the sequence of storage blocks being prepended and appended by additional superblock metadata, and the entirety of the sequence of storage blocks and superblock metadata having a fixed length. The storage record engine 110 may be implemented to write data in an interleaved fashion throughout multiple superblocks in parallel, while each write to each individual superblock progresses sequentially along consecutive storage blocks of that superblock. According to example embodiments of the present disclosure, the storage record engine 110 may configure hosted storage 112 to store multiple superblocks, where, at any given time, a subset of those superblocks are open for writes, and the rest are sealed. Thus, each superblock may include a number of storage blocks encompassing gigabytes of storage space on hosted storage 112. According to example embodiments of the present disclosure, hosted storage 112 as a whole throughout a storage system 100 may store several hundred superblocks.

While any storage blocks of a superblock are not written to, the storage record engine 110 may continue to write to that superblock. Continued writing to a superblock ultimately results in all storage blocks of the superblock becoming fully written. Subsequently, the storage record engine 110 can no longer write to that superblock until the superblock is marked for deletion, so that all storage blocks of the superblock may be marked as invalid and may be reclaimed for further writes.

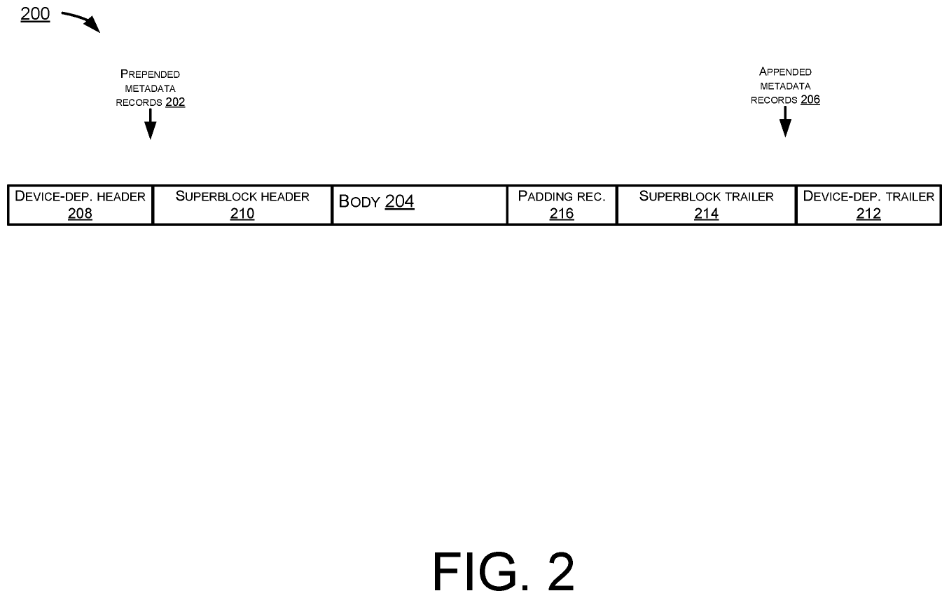

FIG. 2 illustrates a superblock format according to example embodiments of the present disclosure. A superblock 200 includes one or more prepended metadata records 202, a body 204, and one or more appended metadata records 206.

Prepended metadata records 202 may include, for example, any number of device-dependent headers 208 implementing parameters which configure the hosted storage 112 to operate to perform certain functions, as known to persons skilled in the art.

Prepended metadata records 202 may include, for example, a superblock header 210. In contrast to a device-dependent header 208, a superblock header 210 includes metadata which demarcates the start of the body 204 wherein the storage record engine 110 may write storage blocks. Thus, the superblock header 210 is adjacent to the start of the body 204.

The body 204 may include some number of storage blocks, and the storage record engine 110 may write to any number of the storage blocks in order; these storage blocks are not illustrated in further detail herein.

Appended metadata records 206 may include, for example, any number of device-dependent trailers 212 implementing parameters which configure the hosted storage 112 to operate to perform certain functions, as known to persons skilled in the art.

Appended metadata records 206 may include, for example, a superblock trailer 214. In contrast to a device-dependent trailer 212, a superblock trailer 214 includes metadata which demarcates the end of the body 204 wherein the storage record engine 110 may write storage blocks. Thus, the superblock footer 214 is adjacent to the end of the body 204.

As the storage record engine 110 gradually writes to more storage blocks of a superblock 202, storage blocks of the body 204 of that superblock 202 may gradually fill until, while some free space remains among the storage blocks of the body 204, insufficient free space remains for further writes. Thereupon, the storage record engine 110 may be configured to write a padding record 216 into the remaining free space of the body 204, the padding record 216 filling the remaining free space, leaving the body 204 of the superblock 202 fully filled.

Either or both of the superblock header 210 and the superblock trailer 214 may record superblock metadata. According to example embodiments of the present disclosure, superblock metadata may include data records tracking state of a single superblock as a whole. For example, superblock metadata may track whether a superblock is open or sealed; a superblock which is open may be written to until becoming fully filled as described above, whereupon it may be sealed, preventing further writes thereto.

Additionally, while a “chunk” may have certain meanings in the context of file systems and data storage, for the purpose of example embodiments of the present disclosure, a chunk should be understood as a unit of storage written to hosted storage 112, and organized, in subunits referred to as chunk segments. Each chunk segment may be written in a storage block of a superblock. While each chunk segment of a chunk according to example embodiments of the present disclosure should be traversed in a logically contiguous manner, chunk segments are not necessarily contiguous within any one superblock, and chunk segments of a same chunk may be written across any number of superblocks of the same hosted storage 112.

Therefore, as a chunk does not occupy physically contiguous storage space, a chunk according to example embodiments of the present disclosure refers to one or more sets of chunk metadata describing some number of chunk segments logically organized into a common chunk; superblocks where those chunk segments are located; and the locations of those chunk segments within each such superblock. According to example embodiments of the present disclosure, a chunk includes at least two sets of chunk metadata: henceforth, “individual chunk metadata” shall be used to refer to metadata which describes chunk segments of a single chunk (which may span several superblocks), and “chunk segment index map” shall be used to refer to metadata which describes each individual chunk segment.

Additionally, according to example embodiments of the present disclosure, a chunk segment may be made up of some number of records each written to a storage devices of hosted storage 112. For example, on sequentially written storage devices, the records may be written by appending. Whereas basic data structures such as superblocks and chunks may be described by logical addresses mapped to physical addresses on storage devices, records may be described solely by physical addresses on storage devices.

Therefore, the sets of chunk metadata as described above, including individual chunk metadata and chunk segment index maps, describe, respectively, chunks and chunk segments made up of some number of records. These sets of chunk metadata logically map files and/or data store entries (which end devices 108 may specify by persistent storage transactions as implemented by a storage record engine 110) to physical addresses of records which logically make up chunks which, in turn, make up those files and/or data store entries.

Individual chunk metadata may record, for example, a length of the individual chunk; a number of chunk segments making up the individual chunk; a chunk identifier uniquely identifying the chunk; whether the chunk is open or sealed for further writes; and such information relevant to logical organization of a chunk and constituent structures thereof, and reads and writes to the chunk and constituent structures thereof.

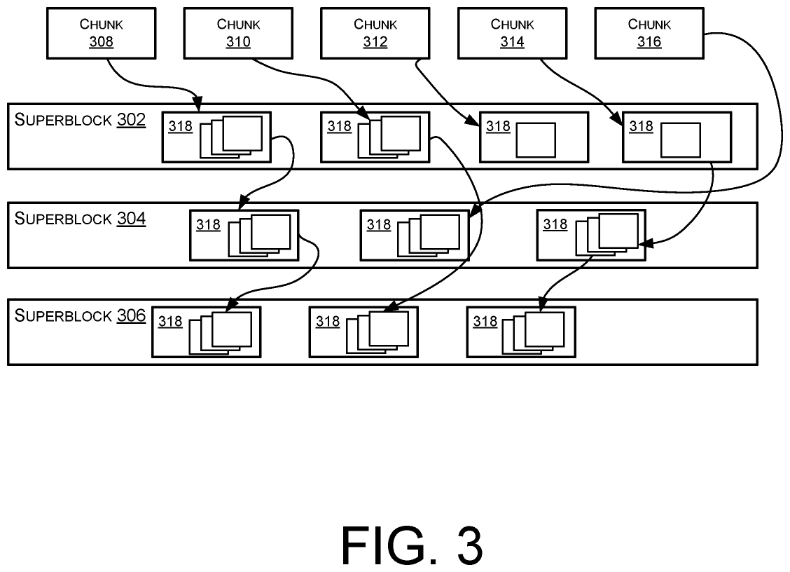

FIG. 3 illustrates layout of data structures according to example embodiments of the present disclosure. Three superblocks 302, 304, and 306 are illustrated, respectively numbered 0, 1, and 2 according to their organization on hosted storage 112. As illustrated, superblock 302 is open, superblock 304 is sealed, and superblock 306 is sealed.

Additionally, five chunks 308, 310, 312, 314, and 316 are illustrated, respectively numbered 1, 2, 3, 4, and 5 according to their order of creation. As illustrated, the blocks corresponding to chunks 308 to 316 do not represent data of each respective chunk (i.e., chunk segments of each respective chunk), but rather represent individual chunk metadata of each respective chunk.

As further illustrated in FIG. 3, each of the chunks 308 to 316 is trailed by a sequence of arrows leading to a sequence including some number of chunk segments, which may include any, some, or all of: one or more segments of superblock 302, one or more chunk segments of superblock 304, and one or more chunk segments of superblock 306.

As illustrated, each chunk segment is illustrated as a block containing some number of records, the records being illustrated as overlapping blocks where multiple records are shown in one chunk segment. Each individual chunk segment is numbered interchangeably herein with reference numeral 318. The records making up each chunk segment may be described by a chunk segment index map corresponding to that chunk segment. Thus, each instance of a chunk segment 318 should be understood as some number of records collectively described by one chunk segment index map.

Each chunk segment index map may identify an individual chunk segment spanning a particular range of storage space by a chunk segment identifier uniquely identifying the chunk segment, and may furthermore identify each record of the chunk segment by a chunk segment offset within the storage space spanned by the chunk segment, the chunk segment offset identifying an offset address where the record begins. By recording a chunk segment offset for each record within a chunk segment, the chunk segment index map enables all records within a chunk segment to be sorted by offset addresses.

It should be further understood that, within each chunk, all chunk segments (regardless of which superblock they belong to) may be tracked in a sorted order by the individual chunk metadata of that chunk.

It should be further understood that, within each superblock, all chunk segments (regardless of which chunk they belong to) may be collectively tracked by superblock metadata therein.

Thus, it should be understood that according to example embodiments of the present disclosure, chunk segments may be organized in at least two dimensions: a dimension logically organized according to individual chunk metadata, and a dimension logically organized according to superblock metadata. A chunk segment index map may be applicable to logical organization of both of these dimensions.

By implementation of a storage system 100 as described above, persistent storage transactions may originate from end devices 108, which may communicate with the storage record engine 110 by a network connection as described above, causing the storage record engine 110 to execute the persistent storage transactions. The execution of the persistent storage transactions may include the storage record engine 110 writing records making up one or more chunk segments; writing chunk segment index maps which map the records to chunk segments; writing individual chunk metadata which maps the one or more chunk segments to one or more chunks; and writing superblock metadata which maps the one or more chunk segments to one or more superblocks.

According to example embodiments of the present disclosure, the storage record engine 110 is further configured to record each such metadata write operation performed by the storage record engine 110, as described above, as a transaction log entry. In order to utilize bandwidth of distributed storage, the storage record engine 110 may be configured to perform massive volumes of concurrent persistent storage transactions. To facilitate this concurrency, the storage record engine 110 may be configured to write the metadata write operations in a transaction log (improving speed of each write operation and decreasing blocking), rather than immediately commit the metadata write operations by permanent writes on storage devices. As a consequence, and as known to persons skilled in the art with respect to implementation of journaling file systems and the like, replay of the transaction log may be understood as an operation wherein each transaction recorded in the transaction log is performed in order, causing each recorded operation to be reconstructed in the process of committing the operations to hosted storage.

Committing of operations recorded in a transaction log may be performed periodically during routine operation of the storage system 100, and, additionally, may be performed during recovery operations of the storage system 100 following a failure of the storage system 100 which results in loss of all data written in memory of the storage system 100. In each case, operations recorded in the transaction log following a latest checkpoint may be committed.

For example, during routine operation of the storage system 100, the storage record engine 110 may record operations in a transaction log until the transaction log reaches a size threshold; upon the transaction log reaching a size threshold, the storage record engine 110 persistently writes previous operations recorded in the transaction log in a checkpoint, thus committing all such operations to hosted storage. The committed operations may then be marked so that they may be discarded to reclaim storage space.

The size threshold may be configured so that, upon the size threshold being triggered, a checkpoint which is subsequently written will be of a certain size. For example, according to example embodiments of the present disclosure, each checkpoint may be 4 gigabytes in size. Therefore, during normal operation of the storage system 100, periodically, approximately 4 gigabytes of transaction log data written following a latest checkpoint will be committed in a new checkpoint.

However, following a failure of the storage system 100, it is expected that some number of operations written to a transaction log following a latest checkpoint have not yet been committed to a checkpoint. Thus, these operations must be replayed in order to recover the state of the hosted storage 112 at the time of the failure. Though this quantity of transaction log data will be less than the size of a checkpoint, it may still be substantially large in volume. Thus, shortly after a storage system 100 is restored to online status following a failure, in order to restore normal operation in due course without causing service deficiency or outage, there is a need to promptly replay a substantial volume of transaction log data without preempting other activity at the hosted storage 112 of the storage system 100.

Aside from such differences as noted above, example embodiments of the present disclosure as described subsequently may otherwise operate in substantially similar fashions in either case as described above.

As described above, persistent storage transactions recorded in a transaction log include writes to metadata including superblock metadata, individual chunk metadata, and chunk index segment index maps. Each category of metadata should be reconstructed during a committing process as described above, as data integrity is compromised in the absence of metadata accurately mapping committed records at physical addresses to logical addresses and logical organization. However, given that the transaction log since the latest checkpoint may have grown to substantial sizes, such as the 4 gigabyte threshold as mentioned above, replay of the entire transaction log since the latest checkpoint may occupy substantial computational resources and preempt other activity at storage devices making up hosted storage 112 of the storage system 100.

Since storage systems 100 according to example embodiments of the present disclosure may be implemented on a cloud network 102 to service many end devices 108, many concurrent read and write transactions may occur while serving calls from the end devices 108. Thus, replay of a transaction log in a manner as described above may cause performance of the storage system 100 to degrade noticeably, including from the perspective of end devices 108.

Consequently, example embodiments of the present disclosure provide a persistent storage transaction commitment method, wherein a storage record engine is configured to record persistent storage transactions to hosted storage of a storage system in a transaction log, and, in the course of committing operations recorded in the transaction log to a checkpoint, interleave transaction log writes and checkpoint writes to reduce blocking of transactions.

To accomplish this, according to example embodiments of the present disclosure, the storage record engine 110 is configured to execute a persistent storage transaction by inserting each persistent storage transaction into one of several write streams of a storage device of the hosted storage 112. Write streams of a storage device may include, for example, a record write stream wherein the storage record engine 110 may insert writes of records; and a metadata write stream wherein the storage record engine 110 may insert writes to a transaction log, as well as checkpoint writes. Each write stream includes an ordered sequence of superblocks configured at the hosted storage 112 by the storage record engine 110; each inserted write may be inserted at a position in the ordered sequence and thus may be written to the corresponding superblock at the position in the ordered sequence. It should be understood that hosted storage 112 according to example embodiments of the present disclosure may include numerous individual storage devices, so all references to a metadata write stream according to example embodiments of the present disclosure may refer to events occurring in any number of instances concurrently at many metadata write streams. However, though example embodiments of the present disclosure are implemented over many metadata write streams, events as described subsequently may occur, and steps may be performed, at each metadata write stream of each storage device. Thus, the perspective of example embodiments of the present disclosure may be fully understood by considering one, some, or all metadata write streams of the hosted storage 112.

According to example embodiments of the present disclosure, a checkpoint may include a sequence of persistently stored records on hosted storage 112 of the storage system 100. The records of a checkpoint, collectively, make up the entirety of data stored in the checkpoint. The storage record engine 110 is configured to insert each record of the checkpoint into a metadata write stream. Records of a checkpoint include checkpoint superblock metadata records, each of which includes an array of superblock metadata; checkpoint chunk metadata records, each of which includes an array of chunk metadata; and checkpoint chunk segment index map records, each of which describes a chunk segment index map. These types of records (henceforth referenced collectively as “checkpoint records”) may each occur anywhere in the checkpoint.

According to example embodiments of the present disclosure, operations are recorded in a transaction log, in the form of records similar to the above types: transaction superblock records each describe a write to superblock metadata as described above; transaction chunk records each describe a write to chunk metadata as described above; and transaction chunk segment index map records each describe a write to a chunk segment index map as described above. Each such type of write, upon being performed during the execution of a persistent storage transaction, causes a transaction log record of the corresponding type to be written. In a transaction log, each new transaction log record may have a header, by which the respective transaction log record may be numbered in sequence.

The vast majority of checkpoint records tend to be chunk segment index maps, due to chunk segments being written in high numbers. In contrast, as relatively few chunks exist compared to chunk segments, and far fewer superblocks exist compared to both chunks and chunk segments, individual chunk metadata occupies fewer checkpoint records compared to chunk segment index maps, and superblock metadata occupies even fewer checkpoint records in comparison.

Additionally, a first record of a checkpoint may be designated as a checkpoint start record, and a final record of a checkpoint may be designated as a checkpoint end record. These two records may each be uniquely identified among all other records of a checkpoint. An entire checkpoint may be identified by a pointer to a start record of the checkpoint. Thus, a latest checkpoint as described above may be identified by any metadata record of any kind pointing to a checkpoint start record of that checkpoint, until a newer checkpoint is fully written, whereupon the pointer is updated to refer to the newer checkpoint.

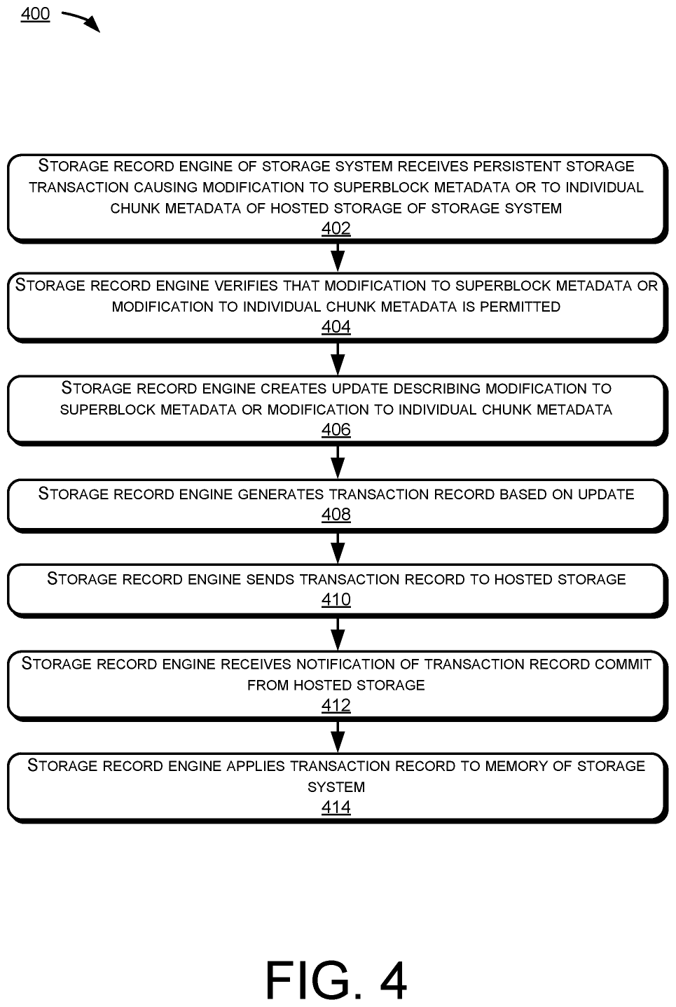

FIG. 4 illustrates a metadata commit method 400 according to example embodiments of the present disclosure.

At a step 402, a storage record engine of a storage system receives a persistent storage transaction causing a modification to superblock metadata or to individual chunk metadata of hosted storage of the storage system.

As described above, a persistent storage transaction may originate from an end device 108—i.e., workloads from end devices 108, requiring storage of data at the storage system 100, make file and/or data operation calls as described above. Alternatively, a persistent storage transaction may originate from the storage record engine 110 itself—i.e., the storage record engine 110 may modify open and sealed statuses of superblocks, modify open and sealed statuses of chunks, and the like.

At a step 404, the storage record engine verifies that the modification to superblock metadata or the modification to individual chunk metadata is permitted.

At a step 406, the storage record engine creates an update describing the modification to superblock metadata or the modification to individual chunk metadata.

The update may describe the modification as a set of syntactical operations upon certain variables of metadata.

At a step 408, the storage record engine generates a transaction record based on the update.

The storage record engine may generate the transaction record by copying at least part of the persistently stored superblock metadata or the persistently stored individual chunk metadata from hosted storage 112; and applying the update to the metadata copy to generate a transaction record.

The transaction record may include a sequence identifier. The sequence identifier may be ordered alongside other sequence identifiers of checkpoints and checkpoint records, as described in further detail below.

At a step 410, the storage record engine sends the transaction record to the hosted storage.

Among the hosted storage, storage devices may, as described above, have a metadata write stream configured to receive writes to a transaction log, and execute those writes at physical addresses of the storage device. Thus, a storage device of the hosted storage may receive the transaction record and commit the transaction record to physical addresses of the storage device.

At a step 412, the storage record engine receives a notification of a transaction record commit from the hosted storage.

The notification may indicate that the transaction record write was successfully committed to a storage device of the hosted storage.

At a step 414, the storage record engine applies the transaction record to memory of the storage system.

At least of the superblock metadata and at least part of the individual chunk metadata may be stored in memory of the storage system. The storage record engine now applies the transaction record to the memory of the storage system, causing modifications to the superblock metadata in memory or modifications to the individual chunk metadata in memory.

According to example embodiments of the present disclosure, it should be understood that, in contrast with superblock metadata and individual chunk metadata, the storage record engine may record modifications to chunk segment index maps directly as transaction chunk segment index map records, without proceeding according to the method 400 as described above.

It should further be understood that transaction chunk segment index map records are only written upon sealing of a superblock in which the respective modified chunk segment index map is located. While a superblock is open, the frequent writing of records to hosted storage by the storage record engine results in frequent modifications to chunk segment index maps of the superblock. Consequently, by avoiding writing transaction chunk segment index map records until the entire superblock is sealed, the ultimate state of all chunk segments of the superblock may be consistently reflected in transaction records.

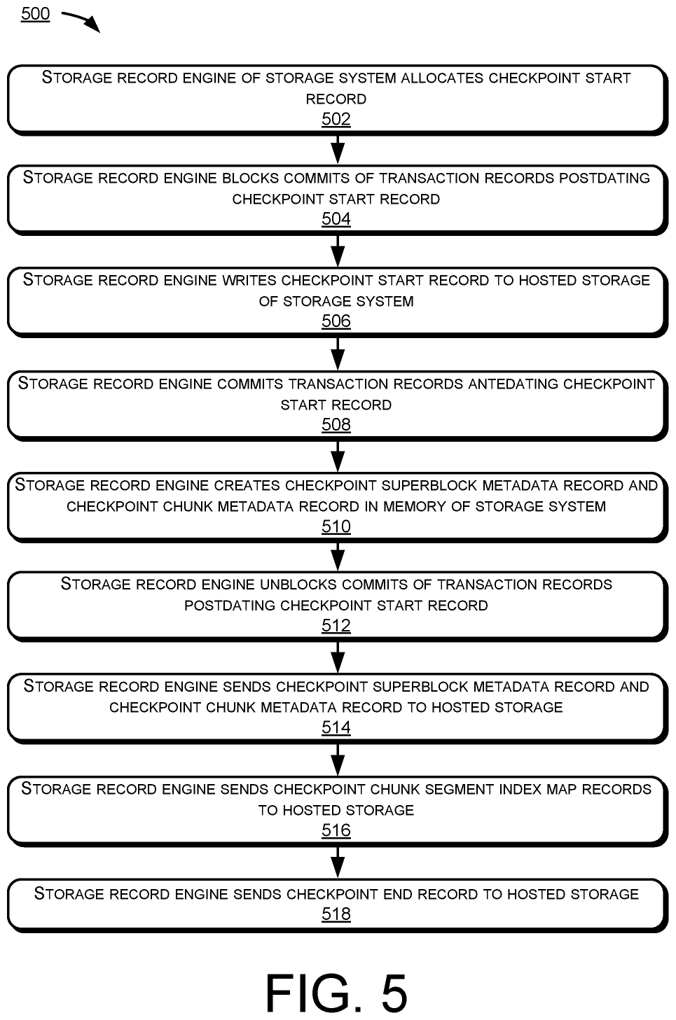

FIG. 5 illustrates a checkpoint write method 500 according to example embodiments of the present disclosure.

At a step 502, a storage record engine of a storage system allocates a checkpoint start record.

Allocation of a checkpoint start record signifies that the storage record engine has started writing a new checkpoint. The checkpoint start record may be identified by a sequence identifier, which may be ordered alongside other sequence identifiers of transaction records, as described above.

At a step 504, the storage record engine blocks commits of transaction records postdating the checkpoint start record.

Transaction records postdating the checkpoint start record may be, for example, transaction records having sequence identifiers higher than a sequence identifier of the checkpoint start record. As a consequence of this step, the storage record engine prevents modifications to superblock metadata and individual chunk metadata in memory of the storage system 100, so that modifications to superblock metadata and individual chunk metadata cannot take place during the writing of a checkpoint.

At a step 506, the storage record engine writes the checkpoint start record to hosted storage of the storage system.

Among the hosted storage, storage devices may have an input/output interface configured to perform read and write operations at physical addresses of the storage device. Thus, a storage device of the hosted storage may receive the checkpoint start record and write the checkpoint start record to physical addresses of the storage device.

At a step 508, the storage record engine commits transaction records antedating the checkpoint start record.

Transaction records antedating the checkpoint start record may be, for example, transaction records having sequence identifiers lower than a sequence identifier of the checkpoint start record. As a consequence of this step, each transaction record antedating the checkpoint start record may be committed before the storage record engine 110 proceeds to the next step 510.

Concurrent to step 508, the storage record engine may also commit transaction records postdating the checkpoint start record, but only proceeding along steps of the method 400 as far as step 412. As a consequence, transaction records postdating the checkpoint start record may be committed as well (though they need not be committed before completion of step 508), but notifications thereof will not be received, and those transaction records will not be applied to memory. Thus, after step 508, consistency of metadata is ensured prior to writing a new checkpoint.

At a step 510, the storage record engine creates a checkpoint superblock metadata record and a checkpoint chunk metadata record in memory of the storage system.

The checkpoint superblock metadata record and the checkpoint chunk metadata record may, respectively, be copied from respective checkpoint metadata records committed to hosted storage of the storage system. The checkpoint superblock metadata record and the checkpoint chunk metadata record may each reflect the consistent state of the metadata following step 508, as described above.

As chunk metadata outnumbers superblock metadata substantially, in order to mitigate the computational intensity of creating checkpoint chunk metadata records, checkpoint chunk metadata records are created from batches of chunk metadata, permitting other writes to take place between batches.

At a step 512, the storage record engine unblocks commits of transaction records postdating the checkpoint start record.

As described above, at this stage, only notifications and applications in memory are blocked for these transaction records; at step 512, notifications and applications in memory are also unblocked, permitting these commits to be completed.

At a step 514, the storage record engine sends the checkpoint superblock metadata record and the checkpoint chunk metadata record to the hosted storage.

At a step 516, the storage record engine sends checkpoint chunk segment index map records to the hosted storage.

At a step 518, the storage record engine sends a checkpoint end record to the hosted storage.

Among the hosted storage, storage devices, as described above, have a metadata write stream configured to receive writes to a checkpoint, and execute those writes at physical addresses of the storage device. Thus, a storage device of the hosted storage may receive each of: the checkpoint superblock metadata record, the checkpoint chunk metadata record, the checkpoint chunk segment index map records, and the checkpoint end records, and commit each category of checkpoint record to physical addresses of the storage device.

In particular, since checkpoint chunk segment index map records are only created upon sealing of the superblocks where respective chunk segment index maps are located, checkpoint chunk segment index map records only exist for sealed superblocks. Consequently, there are no checkpoint chunk segment index map records for modifications to chunk segment index maps of open superblocks; for garbage collection operations upon chunk segment index maps; or chunk segment index maps of deleted superblocks. The absence of these frequent operations from representation in a checkpoint greatly reduces computational overhead of writes to checkpoints, and greatly reduces data to be written to checkpoints.

Additionally, because chunk segment index maps are immutable as a result of superblocks being sealed, each respective checkpoint chunk segment index map record only needs to be written to a checkpoint once. This further reduces computational overhead and data to be written.

According to example embodiments of the present disclosure, steps 514 and 516 are not necessarily performed in order, but may be performed concurrently due to the checkpoint chunk metadata records being written in multiple batches. Thus, checkpoint chunk metadata records will only be written intermittently, rather than in one round; scheduling of different writes of different types of metadata to checkpoints may therefore be made flexible, without writes to one type of metadata preempting writes to other types of metadata for protracted periods of time.

Additionally, according to example embodiments of the present disclosure, steps 514 and 516 of the method 500 may be performed concurrently as step 410 of the method 400: i.e., transaction records and different types of checkpoint records are inserted into metadata write streams of hosted storage 112 in an interleaved fashion. Any number of transaction records and any number of different types of checkpoint records may therefore be committed to hosted storage in any order.

According to example embodiments of the present disclosure, in the course of performing steps 410, 514, and 516, the storage record engine 110 may track a first record chain and a second record chain. Each record chain may include references to records sent to the hosted storage 112. The first record chain may include references to transaction records, while the second record chain may include references to checkpoint records of all types. In this manner, despite the transaction records and each type of checkpoint record being committed to hosted storage 112 in an interleaved fashion, the two record chains may preserve the complete ordered set of transaction records committed to hosted storage 112, and the complete ordered set of checkpoint records committed to hosted storage 112.

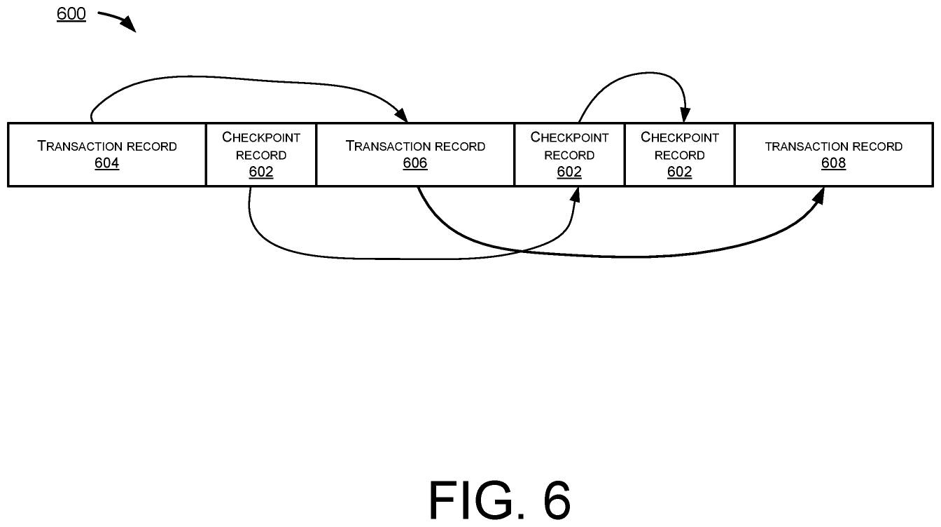

FIG. 6 illustrates a layout of a metadata write stream 600 encompassing records of a first record chain and a second record chain. It can be seen that, among checkpoint records 602 (encompassing multiple types of checkpoint records) of a second record chain, transaction records 604, 606, 608, . . . , of a first record chain are interleaved, where each transaction record is numbered uniquely to indicate that each transaction record is identified by a different sequential identifier. It may be seen that transaction records are larger than checkpoint records.

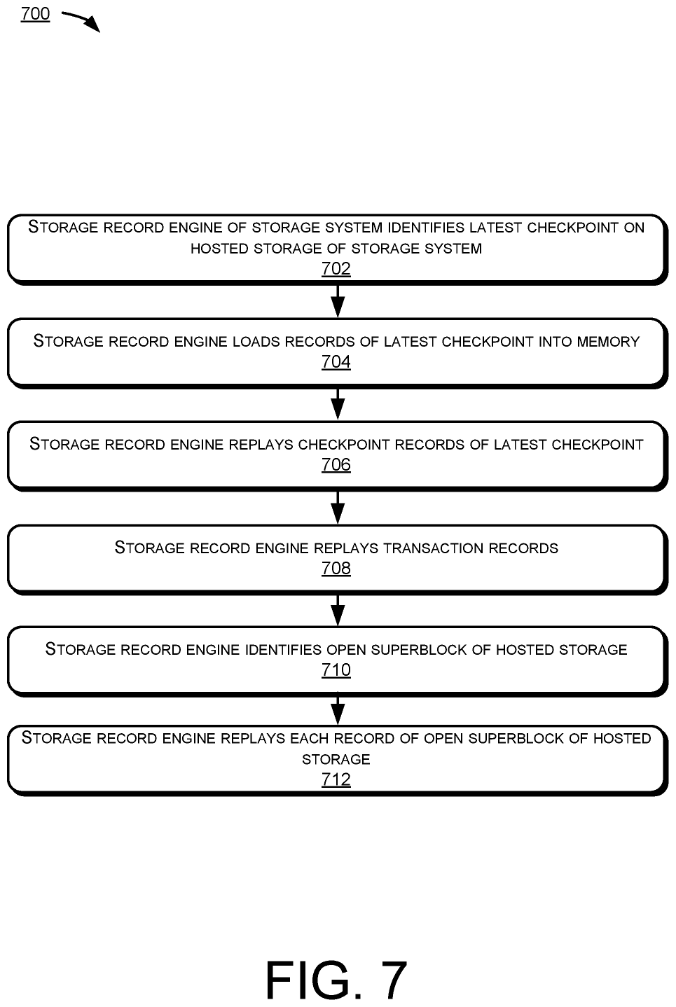

Using the first record chain and the second record chain, example embodiments of the present disclosure further implement a transaction log replay method. FIG. 7 illustrates a transaction log replay method 700 according to example embodiments of the present disclosure.

It should be understood that the transaction log replay method 700 may be applicable both during routine operation of the storage system 100, and during recovery operations of the storage system 100 following a failure thereof, as described above. However, not all steps of the transaction log replay method 700 may be applicable to both cases.

At a step 702, a storage record engine of a storage system identifies a latest checkpoint on hosted storage of the storage system.

As described above, a latest checkpoint may be identified by any metadata record of any kind pointing to a checkpoint start record of that checkpoint. Thus, the storage record engine 110 may scan any pointer to the latest checkpoint from the metadata write stream in order to identify the checkpoint.

In the event that the method 700 is being performed following a system failure, a newer checkpoint postdating the latest checkpoint may be partially written. Since the newer checkpoint will be incomplete, it may be discarded rather than read for the purpose of recovery.

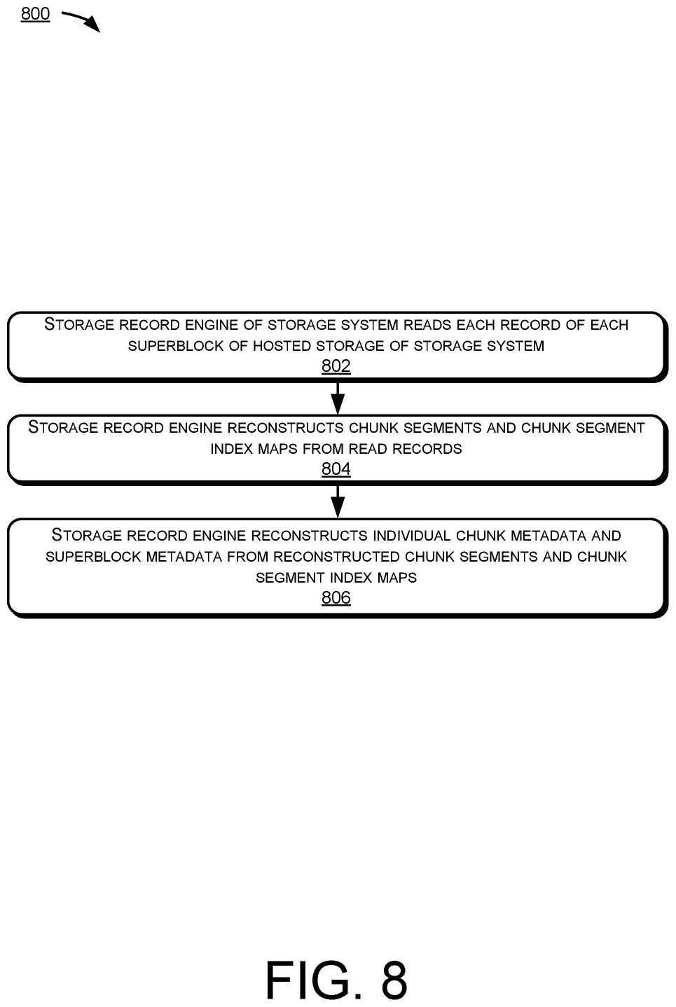

In the event that a latest checkpoint cannot be found or the pointer references an invalid checkpoint, or the metadata write stream has been corrupted by a system failure, the storage record engine 110 may trigger a full recovery scan to be performed upon the entirety of the hosted storage 112. Such a process may be implemented as described subsequently with reference to FIG. 8.

At a step 704, the storage record engine loads records of the latest checkpoint into memory.

In this process, the storage record engine reads and verifies all records of the latest checkpoint, including transaction records and checkpoint records. The storage record engine may set aside each transaction record read between a start record of the checkpoint and an end record of the checkpoint in a section of memory apart from the checkpoint records. For example, the storage record engine may load the checkpoint records into main memory and load the transaction records into a memory cache. Before the transaction records are applied to the checkpoint metadata, the storage record engine will first replay the checkpoint records to place the state of all metadata, according to the various checkpoint records, in memory; this is enabled by the record chains as established previously.

At a step 706, the storage record engine replays checkpoint records of the latest checkpoint.

By following the second record chain, the checkpoint records may be replayed from the hosted storage while skipping transaction records interleaved on the hosted storage between the checkpoint records of the same checkpoint. Therefore, checkpoint records may be replayed expeditiously without traversing all records of a checkpoint. As checkpoint records postdating the latest checkpoint have been discarded, only checkpoint records of the latest checkpoint are replayed.

At a step 708, the storage record engine replays transaction records.

Each transaction record, including transaction records of the latest checkpoint as set aside above, may now be replayed following replay of the checkpoint records. Similarly, by following the first record chain, the transaction records may be replayed while skipping checkpoint records interleaved on the hosted storage between the transaction records in the same checkpoint. As checkpoint records generally outnumber transaction records, the replay process is made substantially expeditious in this manner.

At a step 710, the storage record engine identifies an open superblock of the hosted storage.

During traversal of the checkpoint and replay of transaction records and checkpoint records, the storage record engine may determine that each superblock having a corresponding checkpoint chunk segment index map record is sealed (since these records are only written upon superblock sealing). Therefore, each superblock not having any corresponding checkpoint chunk segment index map record is open, and may contain data not yet recovered in live, non-committed writes to those superblocks.

Open superblocks containing data not yet recovered may be identified by lack of a corresponding checkpoint superblock metadata record, or metadata of the superblock itself not indicating the superblock is sealed.

At a step 712, the storage record engine replays each record of the open superblock of the hosted storage.

In the event that more than one open superblock requires recovery by replay, each open superblock may be ordered by respective sequence numbers thereof.

Replay of records of open superblocks may recover data which has only been partially committed to hosted storage 112; the partially committed data may then be discarded.

FIG. 8 illustrates a full recovery scan method 800 according to example embodiments of the present disclosure. In the absence of replayable checkpoints or metadata, all superblocks may be read and verified as follows, the method 800 being more protracted than the method 700 by necessity, as the entirety of stored data on the storage system must be recovered.

At a step 802, a storage record engine of a storage system reads each record of each superblock of hosted storage of the storage system.

At a step 804, the storage record engine reconstructs chunk segments and chunk segment index maps from the read records.

At a step 806, the storage record engine reconstructs individual chunk metadata and superblock metadata from the reconstructed chunk segments and chunk segment index maps.

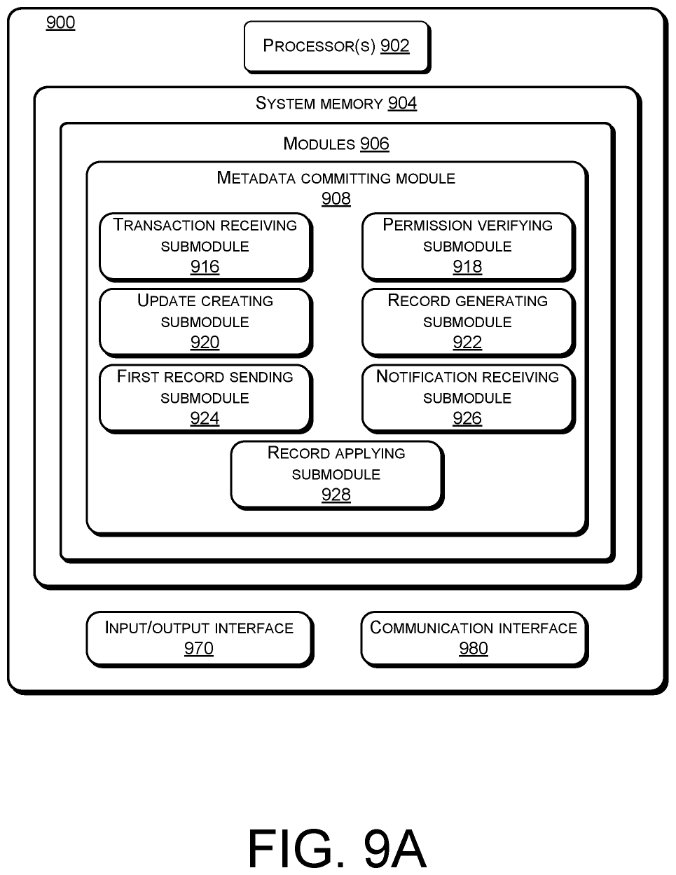

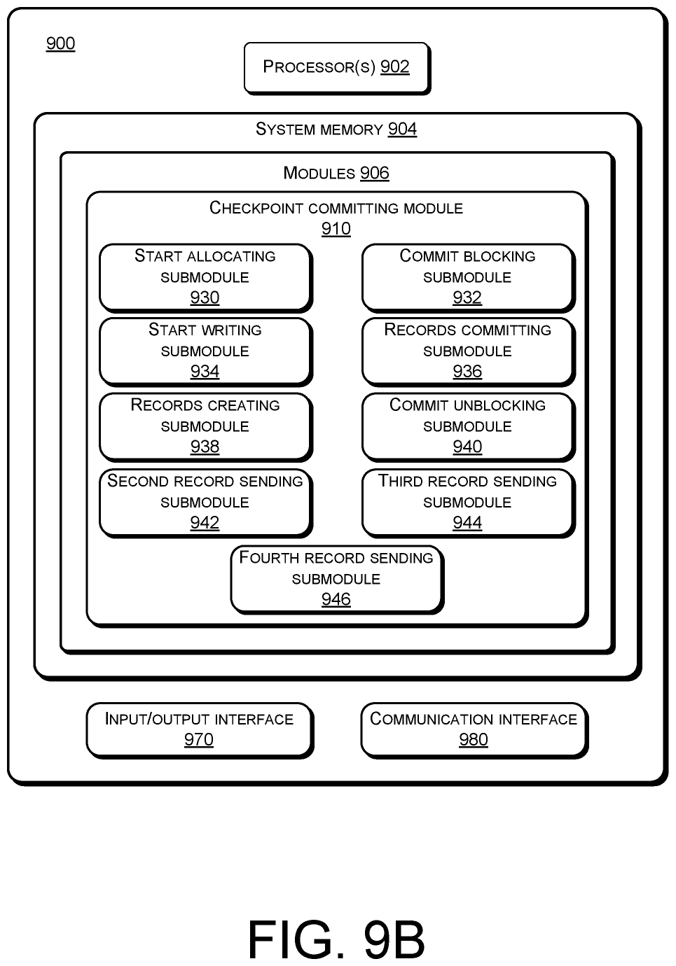

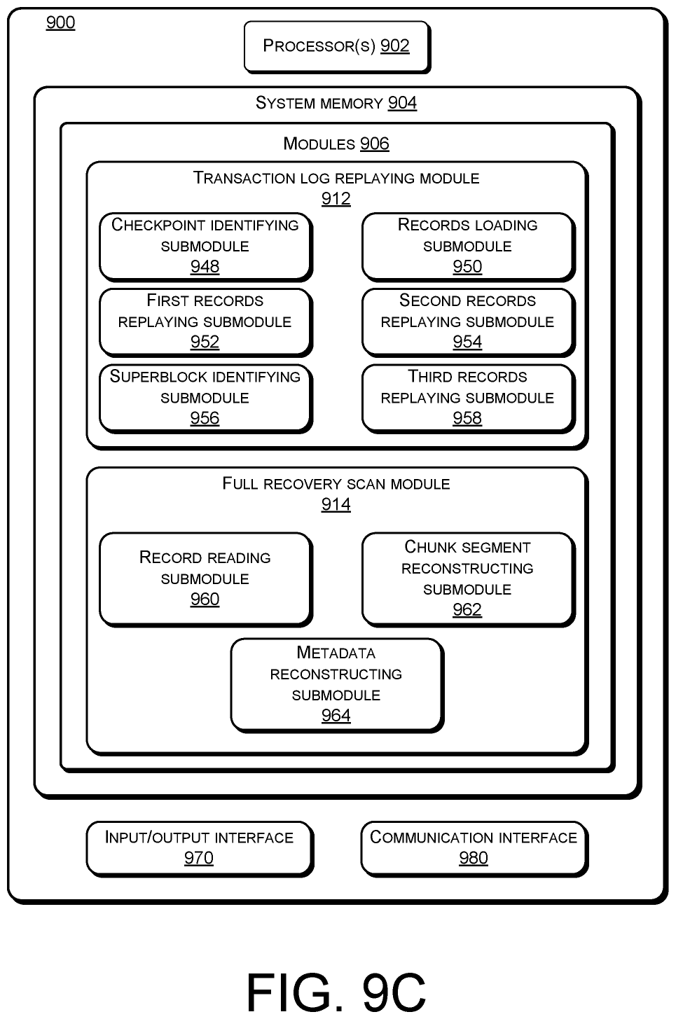

FIGS. 9A through 9C illustrate an example storage system 900 for implementing the processes and methods described above for transaction replay.

The techniques and mechanisms described herein may be implemented by multiple instances of the system 900, as well as by any other computing device, system, and/or environment. The system 900 may be one or more computing systems of a cloud computing system providing physical or virtual computing and storage resources as known by persons skilled in the art. The system 900 shown in FIG. 9 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 900 may include one or more processors 902 and system memory 904 communicatively coupled to the processor(s) 902. The processor(s) 902 and system memory 904 may be physical or may be virtualized and/or distributed. The processor(s) 902 may execute one or more modules and/or processes to cause the processor(s) 902 to perform a variety of functions. In embodiments, the processor(s) 902 may include a central processing unit (“CPU”), a graphics processing unit (“GPU”), both CPU and GPU, or other processing units or components known in the art. Additionally, each of the processor(s) 902 may possess its own local memory, which also may store program modules, program data, and/or one or more operating systems.

Depending on the exact configuration and type of the system 900, the system memory 904 may be volatile, such as RAM, non-volatile, such as ROM, flash memory, miniature hard drive, memory card, and the like, or some combination thereof. The system memory 904 may include one or more computer-executable modules 906 that are executable by the processor(s) 902.

The modules 906 may include, but are not limited to, a metadata committing module 908, a checkpoint writing module 910, a transaction log replaying module 912, and a full recovery scan module 914.

The metadata committing module 908 may further include a transaction receiving submodule 916, a permission verifying submodule 918, an update creating submodule 920, a record generating submodule 922, a first record sending submodule 924, a notification receiving submodule 926, and a record applying submodule 928.

The transaction receiving submodule 916 may be configured to receive a persistent storage transaction causing a modification to superblock metadata or to individual chunk metadata as described above with reference to FIG. 4.

The permission verifying submodule 918 may be configured to verify that the modification to superblock metadata or the modification to individual chunk metadata is permitted as described above with reference to FIG. 4.

The update creating submodule 920 may be configured to create an update describing the modification to superblock metadata or the modification to individual chunk metadata as described above with reference to FIG. 4.

The record generating submodule 922 may be configured to generate a transaction record as described above with reference to FIG. 4.

The first record sending submodule 924 may be configured to send a transaction record as described above with reference to FIG. 4.

The notification receiving submodule 926 may be configured to receive a notification of a transaction record commit from the hosted storage as described above with reference to FIG. 4.

The record applying submodule 928 may be configured to apply a transaction record to memory of the storage system as described above with reference to FIG. 4.

The checkpoint committing module 910 may further include a start allocating submodule 930, a commit blocking submodule 932, a start writing submodule 934, a records committing submodule 936, a records creating submodule 938, a commit unblocking submodule 940, a second record sending submodule 942, a third record sending submodule 944, and a fourth record sending submodule 946.

The start allocating submodule 930 may be configured to allocate a checkpoint start record as described above with reference to FIG. 5.

The commit blocking submodule 932 may be configured to block commits of transaction records postdating the checkpoint start record as described above with reference to FIG. 5.

The start writing submodule 934 may be configured to write the checkpoint start record to hosted storage of the storage system as described above with reference to FIG. 5.

The records committing submodule 936 may be configured to commit transaction records antedating the checkpoint start record as described above with reference to FIG. 5.

The records creating submodule 938 may be configured to create a checkpoint superblock metadata record and a checkpoint chunk metadata record in memory of the storage system as described above with reference to FIG. 5.

The commit unblocking submodule 940 may be configured to unblock commits of transaction records postdating the checkpoint start record as described above with reference to FIG. 5.

The second record sending submodule 942 may be configured to send the checkpoint superblock metadata record and the checkpoint chunk metadata record to the hosted storage as described above with reference to FIG. 5.

The third record sending submodule 944 may be configured to send checkpoint chunk segment index map records to the hosted storage as described above with reference to FIG. 5.

The fourth record sending submodule 946 may be configured to send a checkpoint end record to the hosted storage as described above with reference to FIG. 5.

The transaction log replaying submodule 912 may further include a checkpoint identifying submodule 948, a records loading submodule 950, a first records replaying submodule 952, a second records replaying submodule 954, a superblock identifying submodule 956, and a third records replaying submodule 958.

The checkpoint identifying submodule 948 may be configured to identify a latest checkpoint on hosted storage of the storage system as described above with reference to FIG. 7.

The records loading submodule 950 may be configured to load transaction records of the latest checkpoint into memory as described above with reference to FIG. 7.

The first records replaying submodule 952 may be configured to replay transaction records as described above with reference to FIG. 7.

The second records replaying submodule 954 may be configured to replay checkpoint records of the latest checkpoint as described above with reference to FIG. 7.

The superblock identifying submodule 956 may be configured to identify an open superblock of the hosted storage as described above with reference to FIG. 7.

The third records replaying submodule 958 may be configured to replay each record of the open superblock of the hosted storage as described above with reference to FIG. 7.

The full recovery scan module 914 may further include a record reading submodule 960, a chunk segment reconstructing submodule 962, and a metadata reconstructing submodule 964.

The record reading submodule 960 may be configured to read each record of each superblock of hosted storage of the storage system as described above with reference to FIG. 8.

The chunk segment reconstructing submodule 962 may be configured to reconstruct chunk segments and chunk segment index maps from the read records as described above with reference to FIG. 8.

The metadata reconstructing submodule 964 may be configured to reconstruct individual chunk metadata and superblock metadata from the reconstructed chunk segments and chunk segment index maps as described above with reference to FIG. 8.

The system 900 may additionally include an input/output (I/O) interface 970 and a communication module 980 allowing the system 900 to communicate with other systems and devices over a network, such as the cloud network as described above with reference to FIG. 1. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-8. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides a storage record engine of a storage system. The storage record engine further organizes hosted storage of the storage system into superblocks and chunks organized by respective metadata, the chunks being further organized into chunk segments amongst superblocks. Persistent storage operations may cause modifications to the metadata, which may be recorded in a transaction log, records of which may be replayed to commit the modifications to hosted storage. The replay functionality may establish recovery of data following a system failure, wherein replay of records of transaction logs in a fashion interleaved with checkpoint metadata avoids preemption of normal storage device activity during a recovery process, and improves responsiveness of the storage system from the perspective of end devices.

### Example Clauses

A. A method comprising: sending, by a storage record engine of a storage system, a plurality of transaction records to hosted storage of the storage system; sending, by the storage record engine, a plurality of checkpoint records to the hosted storage such that the plurality of transaction records are interleaved with the plurality of checkpoint records; and replaying, by the storage record engine, the plurality of transaction records as ordered in a first record chain.

B. The method as paragraph A recites, wherein the storage record engine generates a transaction record based on an update describing a modification to superblock metadata of the storage system or a modification to individual chunk metadata of the storage system.

C. The method as paragraph A recites, further comprising: writing, by the storage record engine, a checkpoint start record; and blocking, by the storage record engine, a commit of a transaction record of the plurality of the transaction records; wherein the transaction record antedates the checkpoint start record.

D. The method as paragraph A recites, further comprising sending, by the storage record engine, a checkpoint chunk segment index map record to the hosted storage; wherein the checkpoint chunk segment index map record describes a chunk segment index map stored at a sealed superblock of the hosted storage.

E. The method as paragraph D recites, further comprising identifying an open superblock of the hosted storage based on the checkpoint chunk segment index map record.

F. The method as paragraph A recites, wherein replaying the plurality of transaction records comprises replaying transaction records after replaying checkpoint records of a latest checkpoint.

G. The method as paragraph A recites, wherein the plurality of checkpoint records comprises checkpoint superblock metadata records and checkpoint chunk metadata records, and the plurality of checkpoint records are ordered in a second record chain.

H. A storage system comprising: one or more processors; hosted storage; and memory communicatively coupled to the one or more processors, the memory storing computer-executable modules executable by the one or more processors that, when executed by the one or more processors, perform associated operations, the computer-executable modules comprising: a metadata committing module further comprising a first record sending submodule configured to send a plurality of transaction records to hosted storage of the storage system; a checkpoint committing module further comprising a second record sending submodule configured to send a plurality of checkpoint records to the hosted storage such that the plurality of transaction records are interleaved with the plurality of checkpoint records; and a transaction log replaying module further comprising a first records replaying submodule configured to replay the plurality of transaction records as ordered in a first record chain.

L. The system as paragraph H recites, wherein a transaction record is generated by a record generating submodule of the metadata committing module based on an update describing a modification to superblock metadata of the storage system or a modification to individual chunk metadata of the storage system.

J. The system as paragraph H recites, wherein the checkpoint committing module further comprises: a start writing submodule configured to write a checkpoint start record; and a commit blocking submodule configured to block a commit of a transaction record of the plurality of the transaction records; wherein the transaction record antedates the checkpoint start record.

K. The system as paragraph H recites, wherein the checkpoint committing module further comprises a third record sending submodule configured to send a checkpoint chunk segment index map record to the hosted storage; wherein the checkpoint chunk segment index map record describes a chunk segment index map stored at a sealed superblock of the hosted storage.

L. The system as paragraph K recites, wherein the transaction log replaying module further comprises a superblock identifying submodule configured to identify an open superblock of the hosted storage based on the checkpoint chunk segment index map record.

M. The system as paragraph H recites, wherein the first records replaying submodule is configured to replay the plurality of transaction records by replaying transaction records after checkpoint records of a latest checkpoint are replayed by a second records replaying submodule.

N. The system as paragraph H recites, wherein the plurality of checkpoint records comprises checkpoint superblock metadata records and checkpoint chunk metadata records, and the plurality of checkpoint records are ordered in a second record chain.

O. A computer-readable storage medium storing computer-readable instructions executable by one or more processors, that when executed by the one or more processors, cause the one or more processors to perform operations comprising: sending, by a storage record engine of a storage system, a plurality of transaction records to hosted storage of the storage system; sending, by the storage record engine, a plurality of checkpoint records to the hosted storage such that the plurality of transaction records are interleaved with the plurality of checkpoint records; and replaying, by the storage record engine, the plurality of transaction records as ordered in a first record chain.

P. The computer-readable storage medium as paragraph O recites, wherein the storage record engine generates a transaction record based on an update describing a modification to superblock metadata of the storage system or a modification to individual chunk metadata of the storage system.

Q. The computer-readable storage medium as paragraph O recites, wherein the operations further comprise: writing, by the storage record engine, a checkpoint start record; and blocking, by the storage record engine, a commit of a transaction record of the plurality of the transaction records; wherein the transaction record antedates the checkpoint start record.

R. The computer-readable storage medium as paragraph O recites, wherein the operations further comprise sending, by the storage record engine, a checkpoint chunk segment index map record to the hosted storage; wherein the checkpoint chunk segment index map record describes a chunk segment index map stored at a sealed superblock of the hosted storage.

S. The computer-readable storage medium as paragraph R recites, wherein the operations further comprise identifying an open superblock of the hosted storage based on the checkpoint chunk segment index map record.

T. The computer-readable storage medium as paragraph O recites, wherein replaying the plurality of transaction records comprises replaying transaction records after replaying checkpoint records of a latest checkpoint.

U. The computer-readable storage medium as paragraph O recites, wherein the plurality of checkpoint records comprises checkpoint superblock metadata records and checkpoint chunk metadata records, and the plurality of checkpoint records are ordered in a second record chain.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
sending, by a storage record engine of a storage system, a plurality of transaction records to hosted storage of the storage system;
sending, by the storage record engine, a plurality of checkpoint records to the hosted storage such that the plurality of transaction records are interleaved with the plurality of checkpoint records; and
replaying, by the storage record engine, the plurality of transaction records as ordered in a first record chain.

2. The method of claim 1, wherein a transaction record is generated by the storage record engine based on an update describing a modification to superblock metadata of the storage system or a modification to individual chunk metadata of the storage system.

3. The method of claim 1, further comprising:
writing, by the storage record engine, a checkpoint start record; and
blocking, by the storage record engine, a commit of a transaction record of the plurality of the transaction records;
wherein the transaction record antedates the checkpoint start record.

4. The method of claim 1, further comprising sending, by the storage record engine, a checkpoint chunk segment index map record to the hosted storage;
wherein the checkpoint chunk segment index map record describes a chunk segment index map stored at a sealed superblock of the hosted storage.

5. The method of claim 4, further comprising identifying, by the storage record engine, an open superblock of the hosted storage based on the checkpoint chunk segment index map record.

6. The method of claim 1, wherein replaying, by the storage record engine, the plurality of transaction records is performed after replaying, by the storage record engine, checkpoint records of a latest checkpoint.

7. The method of claim 1, wherein the plurality of checkpoint records comprises checkpoint superblock metadata records and checkpoint chunk metadata records, and the plurality of checkpoint records are ordered in a second record chain.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
a metadata committing module further comprising a first record sending submodule executable by the one or more processors to send a plurality of transaction records to hosted storage of the storage system;
a checkpoint committing module further comprising a second record sending submodule executable by the one or more processors to send a plurality of checkpoint records to the hosted storage such that the plurality of transaction records are interleaved with the plurality of checkpoint records; and
a transaction log replaying module further comprising a first records replaying submodule executable by the one or more processors to replay the plurality of transaction records as ordered in a first record chain.

9. The system of claim 8, wherein the metadata committing module further comprises a record generating submodule executable by the one or more processors to generate a transaction record based on an update describing a modification to superblock metadata of the storage system or a modification to individual chunk metadata of the storage system.

10. The system of claim 8, wherein the checkpoint committing module further comprises:
a start writing submodule executable by the one or more processors to write a checkpoint start record; and
a commit blocking submodule executable by the one or more processors to block a commit of a transaction record of the plurality of the transaction records;
wherein the transaction record antedates the checkpoint start record.

11. The system of claim 8, wherein the checkpoint committing module further comprises a third record sending submodule executable by the one or more processors to send a checkpoint chunk segment index map record to the hosted storage; and
wherein the checkpoint chunk segment index map record describes a chunk segment index map stored at a sealed superblock of the hosted storage.

12. The system of claim 11, wherein the transaction log replaying module further comprises a superblock identifying submodule executable by the one or more processors to identify an open superblock of the hosted storage based on the checkpoint chunk segment index map record.

13. The system of claim 8, wherein the first records replaying submodule is executable by the one or more processors to replay the plurality of transaction records by replaying transaction records after a second records replaying submodule of the transaction log replaying module is executed by the one or more processors to replay checkpoint records of a latest checkpoint.

14. The system of claim 8, wherein the plurality of checkpoint records comprises checkpoint superblock metadata records and checkpoint chunk metadata records, and the plurality of checkpoint records are ordered in a second record chain.

15. A computer-readable storage medium storing computer-readable instructions executable by one or more processors, that when executed by the one or more processors, cause the one or more processors to perform operations comprising:
sending, by a storage record engine of a storage system, a plurality of transaction records to hosted storage of the storage system;
sending, by the storage record engine, a plurality of checkpoint records to the hosted storage such that the plurality of transaction records are interleaved with the plurality of checkpoint records; and
replaying, by the storage record engine, the plurality of transaction records as ordered in a first record chain.

16. The computer-readable storage medium of claim 15, wherein a transaction record is generated by the storage record engine based on an update describing a modification to superblock metadata of the storage system or a modification to individual chunk metadata of the storage system.

17. The computer-readable storage medium of claim 16, wherein the operations further comprise:
writing, by the storage record engine, a checkpoint start record; and
blocking, by the storage record engine, a commit of a transaction record of the plurality of the transaction records;
wherein the transaction record antedates the checkpoint start record.

18. The computer-readable storage medium of claim 16, wherein the operations further comprise sending, by the storage record engine, a checkpoint chunk segment index map record to the hosted storage;
wherein the checkpoint chunk segment index map record describes a chunk segment index map stored at a sealed superblock of the hosted storage.

19. The computer-readable storage medium of claim 18, wherein the operations further comprise identifying, by the storage record engine, an open superblock of the hosted storage based on the checkpoint chunk segment index map record.

20. The computer-readable storage medium of claim 15, wherein replaying, by the storage record engine, the plurality of transaction records is performed after replaying, by the storage record engine, checkpoint records of a latest checkpoint.
